(19) United States
(12) Patent Application Publication
(10) Pub. No.: US 2025/0036491 A1
(43) Pub. Date: Jan. 30, 2025

(54) UNIFIED SCALE-UP/SCALE-OUT INFRASTRUCTURE FOR COMPOSABLE SYSTEMS

(71) Applicant: HEWLETT PACKARD ENTERPRISE DEVELOPMENT LP, Spring, TX (US)

(72) Inventors: FRANK R. DROPPS, Bloomington, MN (US); GARY GOSTIN, Plano, TX (US); THOMAS E. MCGEE, Chippewa Falls, WI (US); GREGORY FANNES, Chippewa Falls, WI (US)

(21) Appl. No.: 18/359,775

(22) Filed: Jul. 26, 2023

(51) Int. Cl. G06F 9/54

(52) U.S. Cl. CPC G06F 9/542

(57) ABSTRACT

Systems and methods are provided for implementing an abstraction layer above the hardware devices with a management controller so that these hardware devices can be combined and presented to the user as a single device for deploying the function. The management controller provides a software interface that provides access to the hardware devices, in a combined or separated state, and generate dynamic configurations of the devices without unplugging any of the hardwired connections. The hardware devices remain connected while they are unused until the function is deployed on one or more of them. The management controller combines the computing functionality of the hardware devices to provide seamless “device” for executing the function/service, which increases the processing power available for the requested function/service.

### BACKGROUND

Traditional systems implement hardware devices in a static format, meaning Network Interface Controllers (NICs) are statically paired together or paired with a switch through wired connections. With the set configurations, hardware devices may be identified to run virtual machines in a portion of the hardware device based on accessibility and computing requirements of a function.

### BRIEF DESCRIPTION OF THE DRAWINGS

The present disclosure, in accordance with one or more various examples, is described in detail with reference to the following figures. The figures are provided for purposes of illustration only and merely depict typical or examples.

FIG. 1 provides an illustrative composable computing system that supports execution of a system configuration operation with a processing function, in accordance with some examples of the disclosure.

FIG. 2 provides an illustrative management controller, in accordance with some examples of the disclosure.

FIGS. 3-8 provide illustrative composable computing systems that support execution of a system configuration operation with a processing function, in accordance with some examples of the disclosure.

FIG. 9 is an example computing component that may be used to implement various features of examples described in the present disclosure.

FIG. 10 depicts a block diagram of an example computer system in which versions of the examples described herein may be implemented.

The figures are not exhaustive and do not limit the present disclosure to the precise form disclosed.

### DETAILED DESCRIPTION

Various traditional systems can implement server nodes and interconnects to switch non-Ethernet packets. The server nodes may each comprise a processor, memory, and switch and configure the switch to connect the server node to other server nodes. However, each of these server nodes may operate independently and provided independent responses to requests to execute functions/services for the user. Additionally, in some examples, the independent server nodes each correspond with a separate Service Set Identifier (SSID) so access to each node is onerous.

Examples of the disclosed technology implement a system that comprises an abstraction layer to provide aggregated functionality of multiple devices that are hard-wired with the system, and the system also comprises the devices in communication with a management controller so that these devices can be dynamically combined and presented to the user as a single device for deploying the function, rather than operate independently and provide independent responses, as in traditional systems. The abstraction layer may form a single Service Set Identifier (SSID) of the devices, where the devices may operate to execute instruction code processing and a combined functionality of the hardware devices to perform “scale-up” functions of the composable computing system. For example, a scale-up cluster is a single system image (SSI) cluster that is viewed as a single system with processing capabilities of each of the interconnected devices in the aggregate. Additional hardware devices may also be added through the pre-existing connections (e.g., hard-wired connections that enable communications) between the devices, which perform “scale-out” functions of the composable system. The management controller can provide a software interface that provides access to the hardware devices, in a combined or separated state, to generate dynamic configurations of the devices without unplugging any of the hard-wire connections. The management controller may be aware of the topology of the entire composable computing system and may have the ability to access each device individually. The server nodes and other hardware devices may remain physically connected via physical connects. In this sense, the management controller combines the computing functionality of the hardware devices that are accessible by the management controller and capable of executing the function to provide a seamless “device” for executing the function/service, which increases the processing power available for the requested function/service.

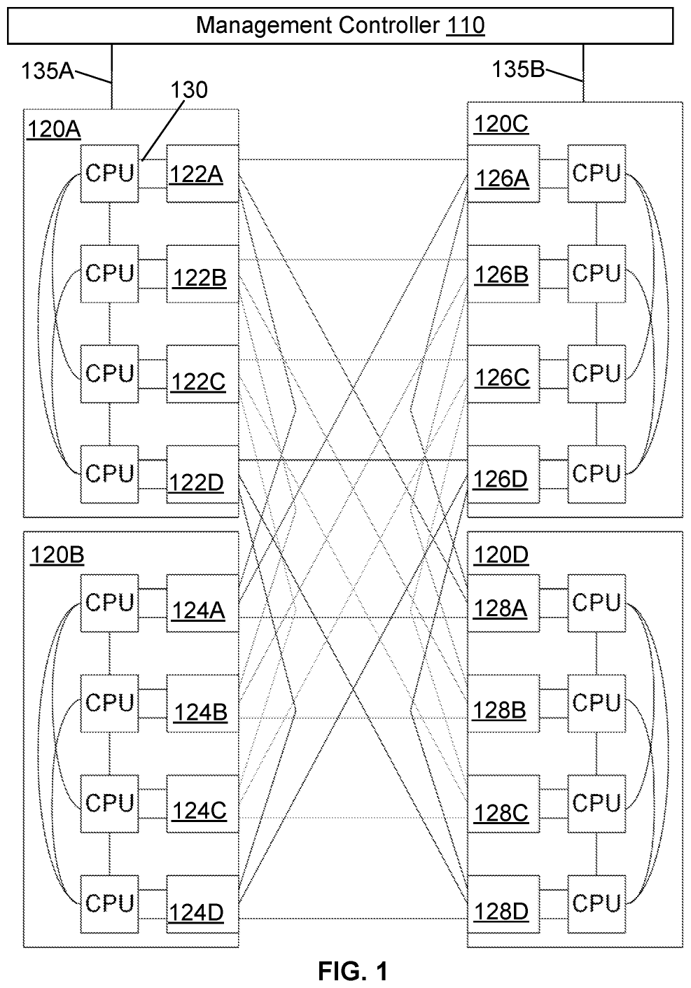

An example of one implementation is provided in FIG. 1, which should not be limiting to the disclosure and drawings and is provided for illustrative purposes only. In this example, four servers 120A-D are shown, each of which include four Application-Specific Integrated Circuit (ASIC) and four Computer Processing Units (CPUs). These ASICs are all connected to CPUs via interconnect 130. Servers 120 (illustrated as first server 120A, second server 120B, third server 120C, fourth server 120D) may comprise a different type of server that is a high-density, four-socket (4S) server with high performance, scalability and reliability, in a 2U chassis. Servers 120A-D may incorporate processors, memory, input/output (IO) of various eight PCIe slots, persistent memory, and automated management/execution through management controller 110.

ASIC 122 (collectively illustrated as first ASIC 122A, second ASIC 122B, third ASIC 122C, fourth ASIC 122D in first server 120A; first ASIC 124A, second ASIC 124B, third ASIC 124C, fourth ASIC 124D in second server 120B; first ASIC 126A, second ASIC 126B, third ASIC 126C, fourth ASIC 126D in third server 120C; and first ASIC 128A, second ASIC 128B, third ASIC 128C, fourth ASIC 128D in fourth server 120D) is an integrated circuit (IC) chip that may be customized for a particular use. In some examples, each of ASIC 122 may integrate all system elements, including firmware, into a single device to enable an abstracted, “scale-up” feature of the composable system that combines ASIC 122 to a single identifier (e.g., the SSID) to support a single system image (SSI).

Various system components may be implemented using these and other features. For example, ASIC 122 may support one or more network devices, such that each device is individually accessible by management controller 110 via interconnect 130. Interconnect 130 may provide wired communication lines between devices throughout the composable computing system.

Management controller 110 is also connected directly or indirectly to each hardware device individually, including each of servers 120, each of ASIC 122, and each CPU. In some examples, interconnect 135 (illustrated as first interconnect 135A and second interconnect 135B) comprises a plurality of connections (e.g., interconnect fabrics) that enable communications between management controller 110 and each device (e.g., servers 120, ASIC 122, CPUs, etc.) in the composable computing system. The communications may be transmitted through the connection lines between management controller 110 and each of the other hardware devices directly or indirectly bypassing information through other devices, which is not shown for simplicity of illustration.

In some examples, the functionality of management controller 110 is incorporated in any of these devices shown in FIG. 1, including any of servers 120, ASIC 122, or CPUs, without a separate device required to perform the operations described herein. In this example, the instructions transmitted by management controller 110 to any of the different devices in the composable computing system may be transmitted through the pre-existing connection that is internal to the device or the pre-existing connection that is external between the different devices.

Technical improvements are realized throughout the disclosure. For example, the disclosed technology can improve computing systems by combining multiple devices to a single interface for simplicity of operation and efficiency of operations between the devices in creating a more powerful device of distributed parts. As a sample illustration, when management controller 110 receives a request to execute a function/service from a user, management controller 110 may determine how much processing, memory, and other execution metrics are required to execute a function/service, determine the devices that are accessible via interconnect 135, determine how many of these accessible devices are required to execute the requested function/service, of the accessible devices select the devices that are also capable of executing the requested function/service, and dynamically combine these accessible/capable devices as a single, abstracted device that will run the function/service. The single, abstracted device may correspond with a single SSID and may optionally execute the function/service as a single system image (SSI) or multiple system images (MSI). The single, abstracted device can produce an output that is provided to the user in response to the requested function/service. Based on pre-existing connections between devices, the software layer abstracts the devices associated with the single SSID without manual intervention, allowing the system to scale up the infrastructure or scale out the infrastructure based on the received function/service request.

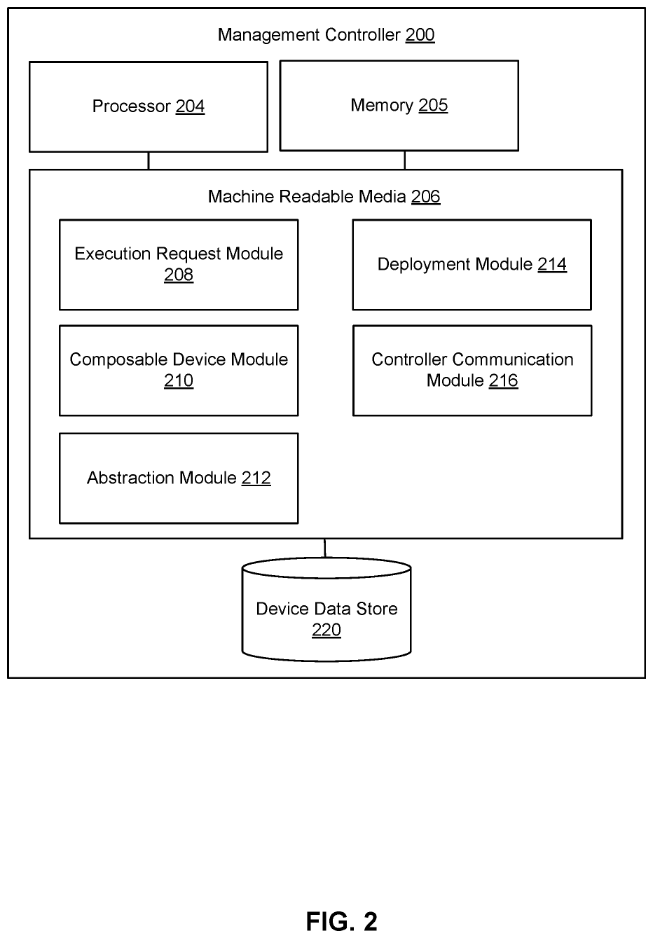

FIG. 2 provides an illustrative management controller, in accordance with some examples of the disclosure. In this example, management controller 200 is a device that comprises processor 204, memory 205, and machine readable media 206. Management controller 200 may correspond with management controller 110 in FIG. 1.

Processor 204 may comprise a general-purpose or special-purpose processing engine such as, for example, a microprocessor, controller, or other control logic. Processor 204 may be connected to a bus or fabric, although any communication medium can be used to facilitate interaction with other components of management controller 110 or to communicate externally.

Memory 205 may comprise random-access memory (RAM) or other dynamic memory for storing information and instructions to be executed by processor 204. Memory 205 might also be used for storing temporary variables or other intermediate information during execution of instructions to be executed by processor 204. Memory 205 may also comprise a read only memory (ROM) or other static storage device coupled to a bus for storing static information and instructions for processor 204.

Machine readable media 206 may comprise one or more interfaces, circuits, and modules for implementing the functionality discussed herein. Machine readable media 206 may carry one or more sequences of one or more instructions to processor 204 for execution. Such instructions embodied on machine readable media 206 may enable the overall system to perform features or functions of the disclosed technology as discussed herein. For example, the interfaces, circuits, and modules of machine readable media 206 may comprise, for example, execution request module 208, composable device module 210, abstraction module 212, deployment module 214, and controller communication module 216.

Execution request module 208 is configured to receive a request to execute a system configuration operation to support a processing function. The request may be received from a user via a client device. In some examples, the request may not identify individual hardware devices in the network. In some examples, the hardware devices may be accessible to management controller 200 as part of a composable computing system and not the client device.

The request may be associated with one or more requester users (e.g., hardware rack administrator, data center administrator, etc.). Each requester user may be associated with a different entity that temporarily utilizes components of the composable computing system to execute functions on its behalf. For example using the exemplary system in FIG. 1, a first requester user may submit a request to execute a system configuration operation that requires three CPUs and three ASICs from a single server and a second requester user may submit a second request to execute a second system configuration operation that requires three servers. Execution request module 208 may receive the first request and coordinate functionality with other management controller 200 modules, including composable device module 210, to identify a first subset of devices that may execute a processing function and also identify a second subset of devices that may execute a processing function associated with the second requester user. Output for both requesters may be provided using the same or different devices from the composable computing system.

Identifiers associated with each device may be stored with device data store 220. Execution request module 208 may access device data store 220 to determine an identifier of the accessible devices (e.g., identifier, International Mobile Equipment Identity (IMEI), interconnect protocol, etc.) and communicate with each device via the stored definition for the device.

In other examples, the devices may be accessible via port configurations through each switch interface. For example, the ports at a switch device can be manually configured with specific duplex and speed settings, or automatically configured when the connection between the device and the switch is plugged into the switch port. The configurations may be automatically negotiated between the device and the switch.

Composable device module 210 is queried to determine a subset of different devices in the composable computing system that are accessible to management controller 200 and/or capable of executing the function. By being accessible, the different devices may receive commands/requests from management controller 200 and management controller 200 may add operations to a queue at the different devices, either directly at the device or through a dispatcher/scheduler component of the composable computing system communicating via interconnect 135. In this way, the requestor may view the system as a black box, where implementation details to perform the scale-up and scale-out functionality of the system are completely determined and executed by management controller 200. Of the devices that are accessible, composable device module 210 also determines which of the subset of different devices in the composable computing system are capable of executing the program function.

The different devices may take many forms. For example, the different devices in the composable computing system may comprise different types of ASIC devices, processors, or other computing systems.

Multiple subsets of different devices in the composable computing system may be determined by composable device module 210 when they are accessible and capable of executing the function/service. For example, a first subset of different devices may be connected to each other by pre-existing connections between the different devices and a second subset of different devices may be separately connected to each other by pre-existing connections between the different devices. Composable device module 210 is configured to communicate and issue requests to each subset separately or in parallel because they are accessible.

The pre-existing connections may take various forms as well. For example, the pre-existing connections may correspond with various protocols to enable the devices to communicate with each other. The pre-existing connections may include, for example, Ethernet, SlingShot (SS), Compute Express Link (CXL), eXternal Global Memory Interconnect (XGMI), Ultra Path Interconnect (UPI), or other component connections, interconnects, and communication protocols.

Subsets of the subset of different devices in the composable computing system may be determined by composable device module 210 because they are accessible and capable of executing the function/service. The subset of the subset of different devices may not include devices that are accessible but not necessarily capable to execute the function currently. Each of the subsets may be combined as an abstracted device for executing a processing function. For example, a first subset of different devices may be connected to each other by pre-existing connections between the different devices, and a second subset of the first subset of different devices may be determined. The second subset of the first subset of different devices may have combined execution capabilities to execute the processing function identified in the request (as shown with execution request module 208).

Abstraction module 212 is configured to dynamically combine the different devices. The dynamic combination of devices may identify the different devices comprising the second subset of the first subset and generate an identifier that collectively instructions the devices as a single abstracted device via the identifier, so that deployment of the processing function to the single abstracted system may collectively instruct the different devices in parallel. The identifier may correspond with an SSID or other identifier. The single abstracted device may communicate with the different devices via the pre-existing connections between the devices to instruct the devices to perform coordinated processing functions.

The combination may be dynamic. For example, the dynamic combination may correspond with the ability to combine the different devices that are accessible to the management controller and capable of executing functions/services (e.g., at a particular time), as needed/per instance. Once these devices are no longer required for a given abstracted system, the abstracted system can be dissembled, making the devices capable of executing different functions/services for another abstracted system. In each of these instances, the devices remain accessible to the management controller. A number of these abstracted systems can be assembled and disassembled, while others continue to perform their intended function. The configuration of any given abstracted system is not determined until a user request is received (e.g., not predetermined) and can change to meet system requirements. In some examples, the abstracted system configuration can be changed to add or remove devices while the intended system processing functions are being performed.

In some examples, the dynamic configuration may be implemented by an external entity. For example, abstraction module 212 may be configured to dynamically identify the devices that comprise the subset of devices that execute the system configuration operation, and the external entity may configure those devices to perform the operations and provide the output/feedback.

In some examples, the devices may be instructed to execute a system configuration operation to support the processing function and then instructed to reboot in a particular configuration determined by abstraction module 212 of management controller 200. When the device comes back online, the connection between these devices is pre-existing and connections between the devices are maintained from before the reboot, and the initial processing functions (after booting/restarting) may be executed to perform the operations in response to the processing function associated with the request.

In some examples, the single abstracted device can communicate with the subset of the first subset of the different devices via the pre-existing connection without manual intervention. For example, management controller 200 may portion the processing function into sub-components and automatically instruct/provide the portions of the processing function to the individual devices.

In some examples, a second controller may be implemented with management controller 200. For example, a first device in the first subset of the different devices in the composable computing system includes the second controller that coordinates internal communication between a plurality of chipsets within the first device, and external communication with management controller 200.

Deployment module 214 is configured to deploy the processing function to the single abstracted system. For example, deployment module 214 of management controller 200 may transmit the processing function associated with the request to execute the system configuration operation to the identifier (e.g., SSID) of the second subset of the first subset of the different devices in the composable computing system that have combined execution capabilities to execute the processing function. The devices may execute processing functions in combination to perform the system configuration operation.

In some examples, deploying the processing function to the single abstracted processing system enables the processing function to operationalize the processing function to the single abstracted processing system.

In some examples, deployment module 214 may receive output from the single abstracted processing system corresponding with the processing function and provide it back to the user that provided the request, such that the output is provided on behalf of management controller 200.

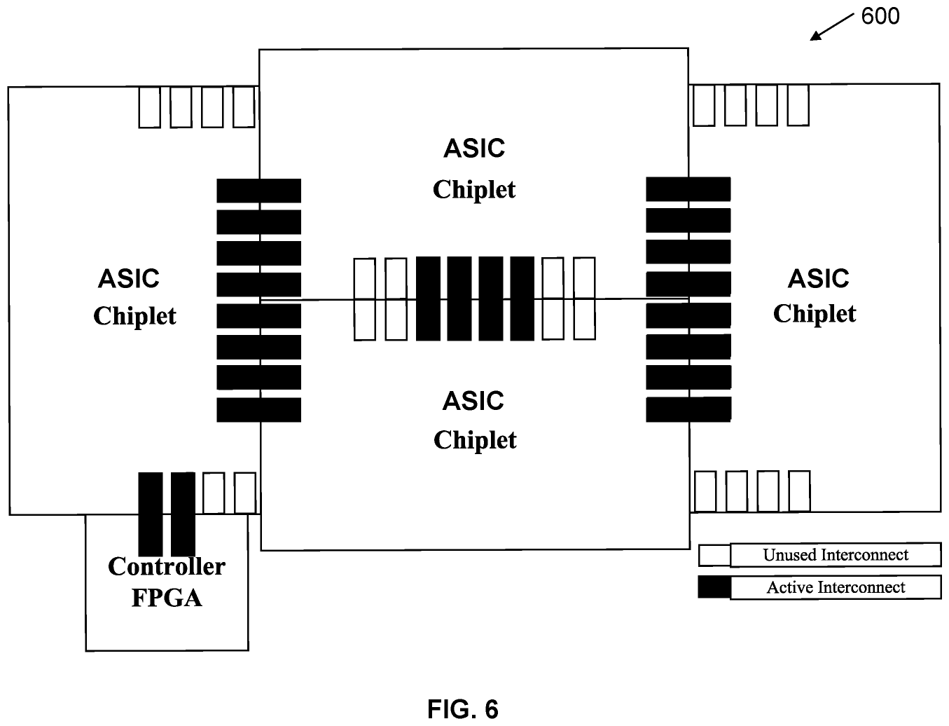

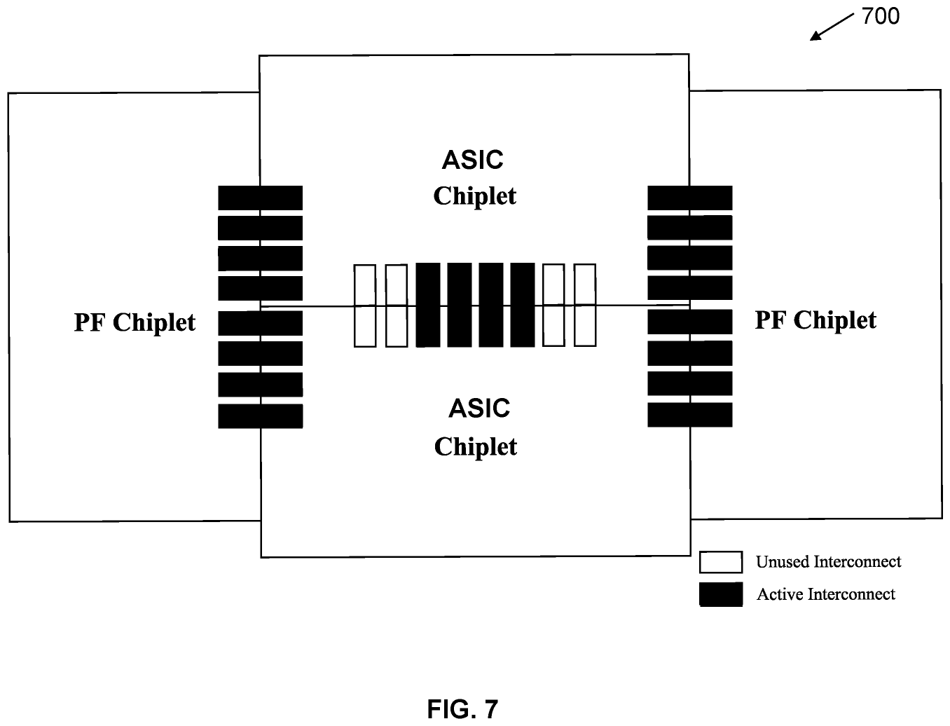

Controller communication module 216 is configured to communicate with additional management controllers in the composable system. For example, some illustrations provided herein include configurations of chiplets on an array die (see e.g., FIG. 6 and FIG. 7). Even though interconnect access is accessible to each of the individual chiplets and capable of executing the functions/services, the secondary management controller incorporated with the array die may be responsible for instructing the chiplets directly in a hierarchy of management controllers. In some examples, management controller 200 may provide the instruction in a first format or interconnect, including CXL, UPI, and SS, and the secondary management controller may convert the instruction to a second format or interconnect, including Universal Chiplet Interconnect Express (UCIe) or Peripheral Component Interconnect Express (PCIe).

As an illustrative example, management controller 200 may provide the instruction to perform a portion of the processing function to the secondary management controller, then the secondary management controller may directly instruct the chiplet to perform the corresponding operations. In some examples, controller communication module 216 of management controller 200 may not have direct access to the chiplets (in the die-to-die interconnect) and may rely on the secondary management controller to provide instruction directly to the chiplets, such that the second management controller can convert the format into a readable version by the chiplet.

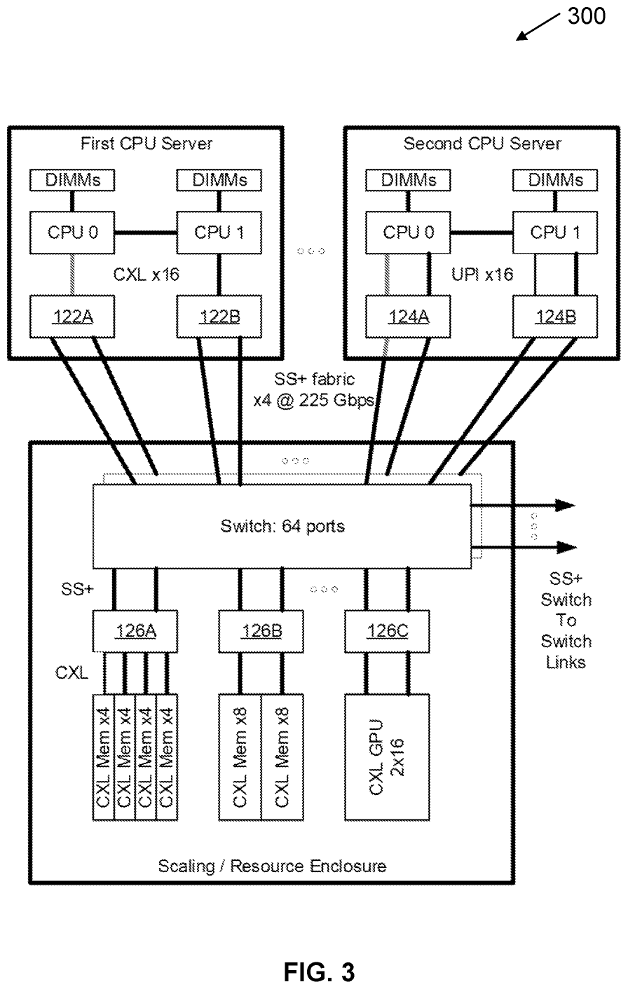

FIGS. 3-8 provide various examples of computing systems where the management controller may receive a request to execute a function/service and determine a set of accessible/capable devices, as described throughout the disclosure. The management controller may represent the various types of illustrative computing systems as a single abstracted device to deploy the processing function.

FIG. 3 provides an illustrative composable computing system that supports execution of a system configuration operation with a processing function, in accordance with some examples of the disclosure. In example 300, a plurality of devices is shown, including servers (e.g., CPU server, GPU server), DIMMs, CPUs, ASIC (illustrated as ASICs 122A, 122B, 124A, 124B), and switch (illustrated as Switch: 64 port). Interconnects may individually access each device/block (e.g., one interconnect between ASIC 126A and each CXL memory ×4). The management controller is not shown in this example, and may be implemented as a separate device or incorporated internally with any of the devices provided.

A plurality of lines are shown between the devices, which correspond with the interconnect of the composable computing system. For example, a first set of pre-existing connections exist internally in each server between DIMMs, CPUs, and ASIC (illustrated as ASICs 122A, 122B, 124A, 124B), and a second set of pre-existing connections exist externally between each server and other devices (illustrated as switch: 64 ports). In other examples, the devices may be replaced with other devices, including memory components, to increase the memory storage capacity of the composable computing system and enable additional memory to be accessible by the management controller (not shown). The interconnect fabric of pre-existing connections may enable the composable computing system to “scale out” or increase in size and functionality to execute the processing function identified by the management controller (not shown).

In this example, an abstracted system topology is provided that can be used for both CXL-based scale-out and scale out devices. For example, different types of servers are interconnected via a Scaling/Resource Enclosure (SRE) into a single cache coherent server of up to 64 sockets. Multiple switches in the SRE are used to provide fabric fault tolerance and the required bandwidths. CXL memory within the SRE can also be assigned to the server as cache coherent fabric attached memory (FAM) to expand memory independently from central processing units (CPUs). The ASICs 122A, 122B, 124A, 124B within the SRE communicate with each other via switch to provide memory Redundant Array of Independent Disks (RAID) across groups of CXL memory modules. This same topology with CXL from the CPUs to 122A, 122B, 124A, 124B provides a large, scale-out system consisting of CPUs, GPUs, FAM, and other devices. CXL 3.0 is defining Port Based Routing packet formats that will support 4096 total fabric endpoints. To reach this scale, SREs can be interconnected via SS+ links using fabric topologies such as Dragonfly™ or HyperX™ to provide systems with thousands of CPUs, GPUs, and FAM modules with high throughput and extremely low latencies. The proven interconnect fabric technology dynamically detects fabric congestion and routes traffic across all accessible paths to maximize fabric throughput under heavy load.

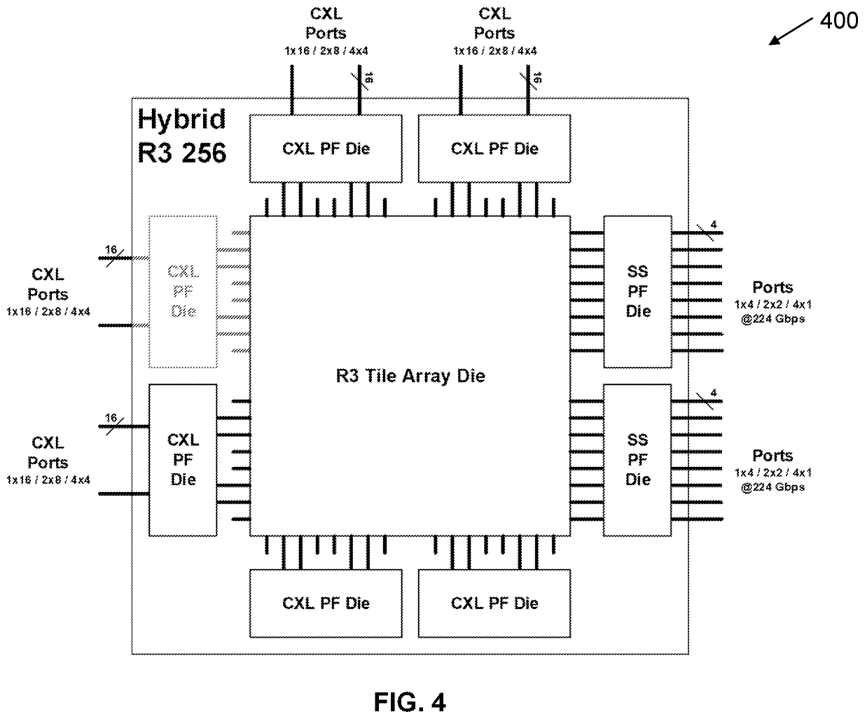

FIG. 4 provides an illustrative composable computing system that supports execution of a system configuration operation with a processing function, in accordance with some examples of the disclosure. In example 400, a plurality of devices are shown as chiplets and an array die. The chiplets and array die can be used in a system configuration operation to generate a scaled-out device that is more powerful than any single chiplet or array die in the composable computing system.

Each of the devices are connected via the pre-existing connections. Illustrative interconnect types are provided in the example, including CXL, UPI, and SS, which may form the overall interconnect for the composable computing system. The management controller may transmit an instruction via the interconnect to any device individually to execute a portion of the processing function to perform a system configuration operation.

In this example, the switch core with dynamic routing and congestion management functions may be implemented on a protocol agnostic Tile Array Die, while the protocol specific functions may be implemented on a die/chiplet. The ports may comprise CXL ports 1×16, 2×8, or 4×4 or PF ports 1×4, 2×2, or 4×1 at 224 Gbps. To add CXL or UPI ports to switch, a PF chiplet can be designed that implements all CXL/UPI specific protocol functions. When this exchange is done, a new substrate and package would likely be required. This example provides a possible hybrid switch configuration with six of the PF chiplets replaced with other types of chiplets to produce a high radix hybrid switch with 12 CXL/UPI ports and 16 fabric ports for multi switch links.

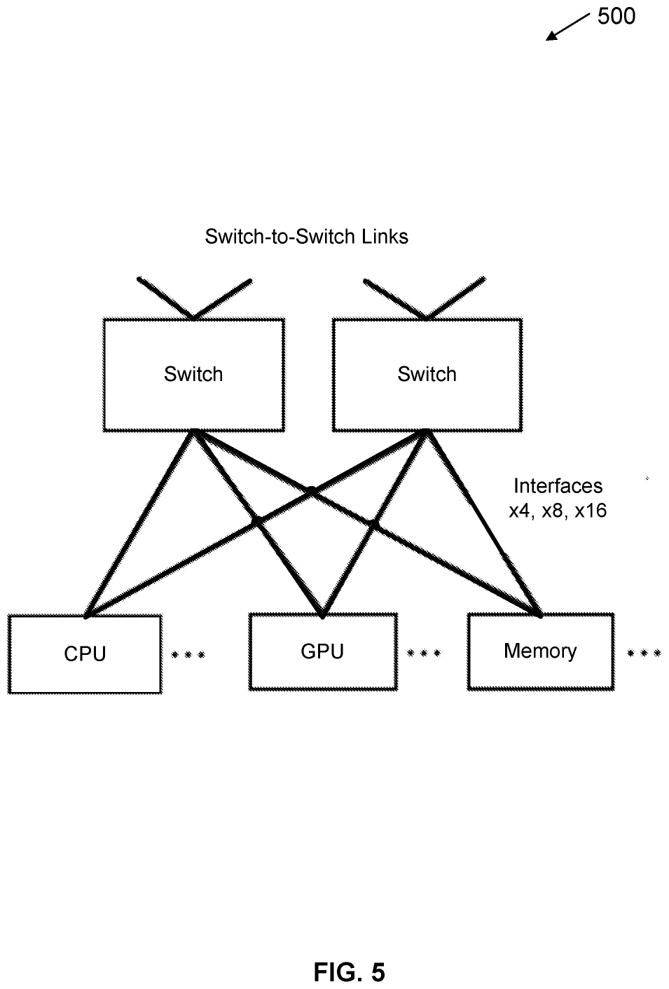

FIG. 5 provides an illustrative composable computing system that supports execution of a system configuration operation with a processing function, in accordance with some examples of the disclosure. In example 500, the switch (illustrated as Switch: 64 Ports in FIG. 3) may be combined with other switches to increase the functionality and processing capability of using a single switch. The switches may be combined through the pre-existing connections between each switch and corresponding devices.

In this example, the hybrid switch would connect directly to CXL or UPI devices. In another embodiment, multiple CXL/UPI PF chiplets could be packaged without the Title Array Die to build an ASIC chiplet. The ASIC chiplet bridges from the CXL or UPI protocol to CXL+ protocol. The CXL+ protocol is based on CXL, but supports additional proprietary features for tunneling other protocols such as UPI or XGMI as well as other protocol enhancements.

FIG. 6 provides an illustrative composable computing system that supports execution of a system configuration operation with a processing function, in accordance with some examples of the disclosure. In example 600, ASIC chiplets are connected via a plurality of active die-to-die connections, where the connections form an interconnect of the composable computing system. Unused connections are also shown between the chiplets. The ASIC chiplets may be incorporated into an 8-port ASIC chiplet in this example, where the 8-port ASIC chiplet in FIG. 6 is similar to a single ASIC 122 illustrated in FIG. 1, such that additional implementation detail is provided in this illustration. Additionally, the configuration details provided in these and other examples are for illustrative purposes only and should not be limiting to the overall functionality described throughout the disclosure.

In this example, a hierarchy of management controllers may be implemented. For example, a secondary management controller may receive the instruction to perform the processing function from management controller 200, and then instruct the individual chiplets incorporated with the array die to perform a portion of the processing function.

In this example, the 8-port ASIC chiplet is formed using multiple chiplets. The middle two chiplets would provide the routing for the far end chiplets that are not directly connected to each other. This illustration shows ASIC chiplets directly connected, and it would also be possible to mix ASIC and PF chiplets, as shown in FIG. 7 below, to allow for a multi-chiplet fabric system interconnect in the system configuration.

FIG. 7 provides an illustrative composable computing system that supports execution of a system configuration operation with a processing function, in accordance with some examples of the disclosure. In example 700, various types of chiplets are connected into an 8-port ASIC chiplet, including a plurality of ASIC chiplets and PF chiplets. The 8-port ASIC chiplet in FIG. 7 is similar to a single ASIC 122 illustrated in FIG. 1, such that additional implementation detail is provided in this illustration. Each of the different types of chiplets are connected via a plurality of active die-to-die connections, where the connections form an interconnect of the composable computing system. Unused connections are also shown between the chiplets.

A similar hierarchy of management controllers may be implemented in FIG. 7, as shown in FIG. 6, including converting format types within the interconnect. For example, converting a first interconnect format as CXL, UPI, or SS, to a second interconnect format as UCIe or PCIe.

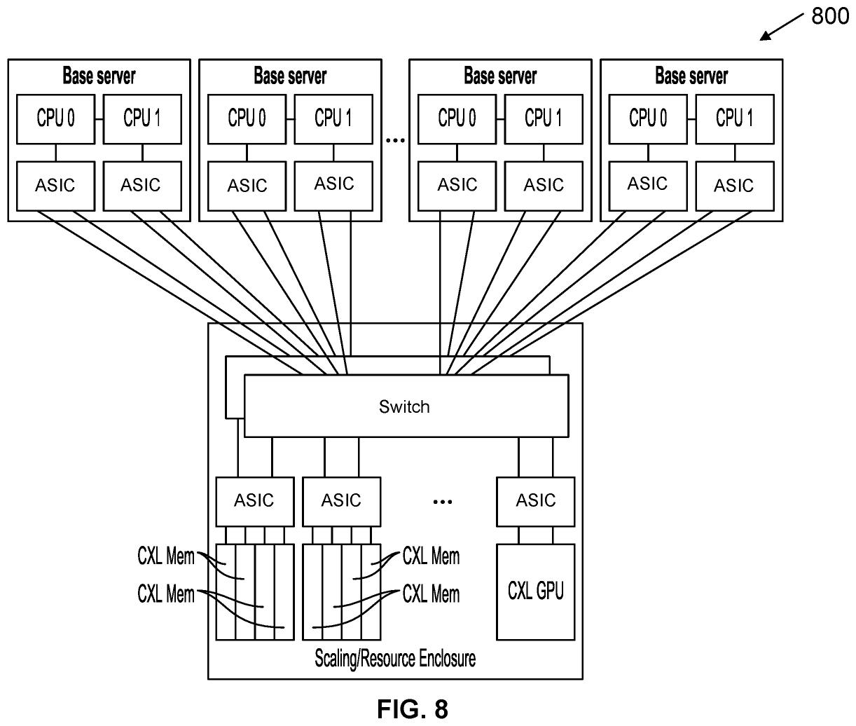

FIG. 8 provides an illustrative composable computing system that supports execution of a system configuration operation with a processing function, in accordance with some examples of the disclosure. In example 800, a plurality of devices are shown and the management controller is not shown, as illustrated in FIG. 3, in addition to some of the devices corresponding with memory accessible by one or more ASICs.

The components and devices described herein can provide a building block of larger systems that can be dynamically combined in a composable computing system. In this example, the number of servers can be adjusted by using more or less of the Rossetta-3 switch's 64 ports.

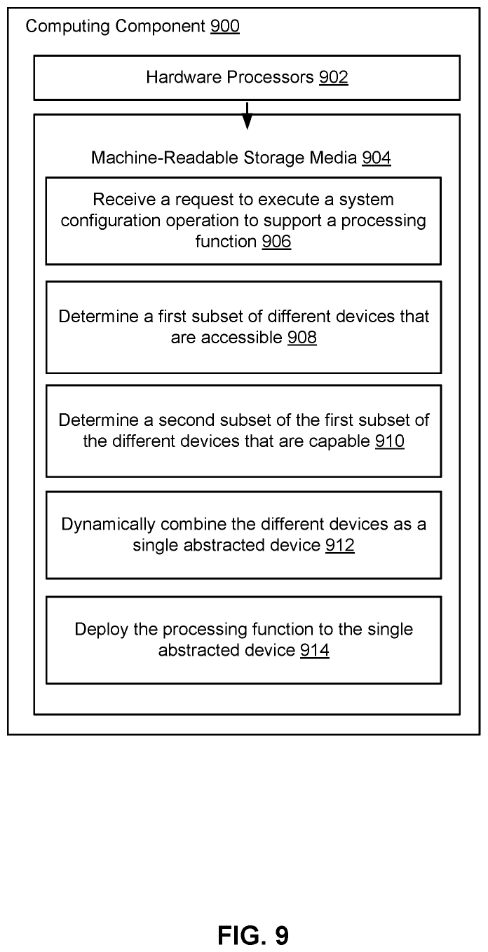

FIG. 9 illustrates an example computing component that may be used to implement the dynamically modular and customizable computing systems in accordance with various examples. Referring now to FIG. 9, computing component 900 may be, for example, a server computer, a controller, or any other similar computing component capable of processing data. In the example implementation of FIG. 9, the computing component 900 includes a hardware processor 902, and machine-readable storage medium for 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-914, to control processes or operations for implementing the dynamically modular and customizable computing systems. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-914.

Hardware processor 902 may execute instruction 906 to receive a request to execute a system configuration operation to support a processing function. The request may be received by a management controller of a composable computing system. For example, the request may comprise a request to execute a function/service from a user.

Hardware processor 902 may execute instruction 908 to determine a first subset of different devices that are accessible. The first subset of different devices are connected by pre-existing connections between the different devices. The determination may be made by the management controller of the composable computing system.

Hardware processor 902 may execute instruction 910 to determine a second subset of the first subset of different devices in the composable system that are capable. The second subset of devices being capable when they have combined execution capabilities to execute the processing function. The determination may be made by the management controller of the composable computing system.

Hardware processor 902 may execute instruction 912 to dynamically combine the different devices as a single abstracted device. The combination may comprise the second subset of the first subset as a single abstracted device. The single abstracted device may communicate with the second subset of the first subset of different devices via the pre-existing connections to perform coordinated processing functions. The dynamic combination may be implemented by the management controller of the composable computing system.

As an illustrative example, the management controller may parse the request after it is received at block 906 to determine how much processing, memory, and other execution metrics are required to execute a function/service. The management controller may use this information to determine the devices that are accessible via interconnect at block 908 and determine how many of these available devices are capable/required to execute the requested function/service at block 910. The management controller may dynamically combine these accessible devices that are capable of executing the function/service as a single, abstracted device that will run the function/service at block 912. The single, abstracted device may correspond with a single SSID and may optionally execute the function/service as a single system image (SSI) or multiple system images (MSI).

Hardware processor 902 may execute instruction 914 to deploy the processing function to the single abstracted device. The deployment of the processing function may be implemented by the management controller of the composable computing system. In some examples, the single, abstracted device can produce an output that is provided to the user in response to the requested function/service.

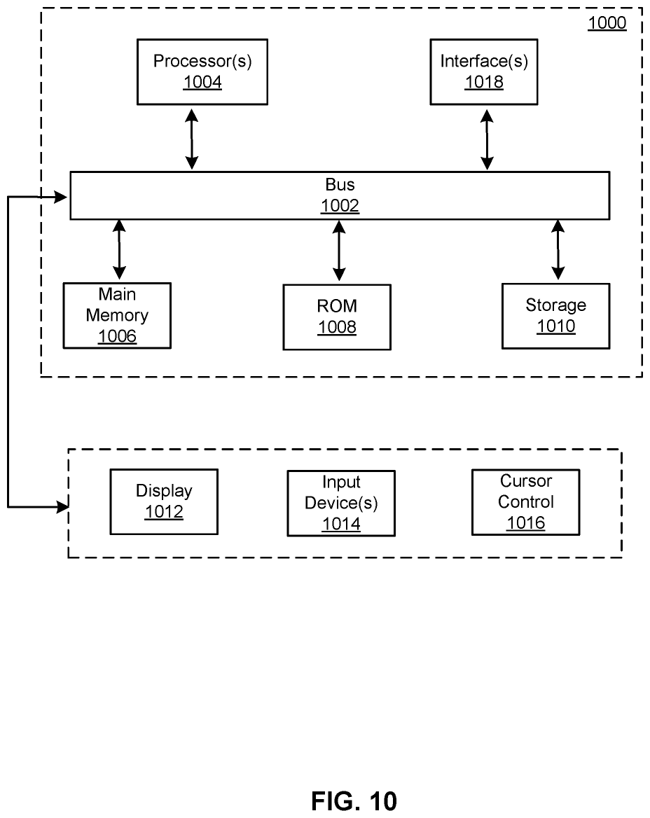

FIG. 10 depicts a block diagram of an example computer system 1000 in which various of the examples described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some examples, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one example, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication interface 1018 coupled to bus 1002. Communication interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN (or WAN component to communicated with a WAN). Wireless links may also be implemented. In any such implementation, communication interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1018, which carry the digital data to and from computer system 1000, are example forms of transmission media.

The computer system 1000 can send messages and receive data, including program code, through the network(s), network link and communication interface 1018. In the Internet example, a server might transmit a requested code for an application program through the Internet, the ISP, the local network and the communication interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

What is claimed is:

1. A method comprising:
receiving, by a management controller of a composable computing system, a request to execute a system configuration operation to support a processing function;
determining, by the management controller, a first subset of different devices in the composable computing system that are accessible, the first subset of different devices being connected by pre-existing connections between the different devices;
determining, by the management controller, a second subset of the first subset of different devices in the composable computing system that are capable, the second subset of the first subset having combined execution capabilities to execute the processing function;
dynamically combining, by the management controller, the different devices comprising the second subset of the first subset as a single abstracted device, the single abstracted device communicating with the second subset of the first subset of different devices via the pre-existing connections to perform coordinated processing functions; and
deploying the processing function to the single abstracted device.

2. The method described in claim 1, wherein the different devices in the composable computing system comprise different types of Application-Specific Integrated Circuit (ASIC) devices.

3. The method described in claim 1, wherein the first subset of different devices in the composable computing system are accessible when the different devices receive commands/requests from management controller and the management controller adds operations to a queue at the different devices, either directly at the device or through a dispatcher/scheduler component of the composable computing system.

4. The method described in claim 1, wherein the single abstracted device communicates with the second subset of the first subset of different devices via the pre-existing connections without manual intervention.

5. The method described in claim 1, wherein a first device in the first subset of different devices in the composable computing system includes a second controller that coordinates internal communication between a plurality of chipsets within the first device, and external communication with the management controller.

6. The method described in claim 1, wherein the management controller is in communication with a plurality of interconnect fabrics that enable communications between different devices in the composable computing system.

7. The method described in claim 1, wherein deploying the processing function to the single abstracted device comprises providing, by the management controller, output from the single abstracted device corresponding with the processing function.

8. The method described in claim 1, wherein deploying the processing function enables the processing function to operationalize the processing function to the single abstracted device.

9. A non-transitory computer-readable storage medium storing a plurality of instructions executable by a processor, the plurality of instructions when executed by the processor cause the processor to:
receive a request to execute a system configuration operation to support a processing function;
determine a first subset of different devices in a composable computing system that are accessible, the first subset of different devices being connected by pre-existing connections between the different devices;
determine a second subset of the first subset of different devices in the composable computing system that have combined execution capabilities to execute the processing function;
dynamically combine the different devices comprising the second subset of the first subset as a single abstracted device, the single abstracted device communicating with the second subset of the first subset of different devices via the pre-existing connections to perform coordinated processing functions; and
deploy the processing function to the single abstracted device.

10. The non-transitory computer-readable storage medium described in claim 9, wherein the different devices in the composable computing system comprise different types of Application-Specific Integrated Circuit (ASIC) devices.

11. The non-transitory computer-readable storage medium described in claim 9, wherein the first subset of different devices in the composable computing system are accessible when the different devices receive commands/requests from management controller and the management controller adds operations to a queue at the different devices, either directly at the device or through a dispatcher/scheduler component of the composable computing system.

12. The non-transitory computer-readable storage medium described in claim 9, wherein the single abstracted device communicates with the second subset of the first subset of different devices via the pre-existing connections without manual intervention.

13. The non-transitory computer-readable storage medium described in claim 9, wherein a first device in the first subset of different devices in the composable computing system includes a second controller that coordinates internal communication between a plurality of chipsets within the first device, and external communication with a management controller.

14. The non-transitory computer-readable storage medium described in claim 9, wherein a management controller of the storage medium is in communication with a plurality of interconnect fabrics that enable communications between different devices in the composable computing system.

15. The non-transitory computer-readable storage medium described in claim 9, wherein deploying the processing function to the single abstracted device comprises provide output from the single abstracted device corresponding with the processing function.

16. The non-transitory computer-readable storage medium described in claim 9, wherein deploying the processing function enables the processing function to operationalize the processing function to the single abstracted device.

17. A management controller of a composable computing system comprising:
a memory; and
a processor that are configured to execute machine readable instructions stored in the memory for causing the processor to:
receive a request to execute a system configuration operation to support a processing function;
determine a first subset of different devices in the composable computing system that are accessible, the first subset of different devices being connected by pre-existing connections between the different devices;
determine a second subset of the first subset of different devices in the composable computing system that have combined execution capabilities to execute the processing function;
dynamically combine the different devices comprising the second subset of the first subset as a single abstracted device, the single abstracted device communicating with the second subset of the first subset of different devices via the pre-existing connections to perform coordinated processing functions; and
deploy the processing function to the single abstracted device.

18. The management controller of the composable computing system described in claim 17, wherein the different devices in the composable computing system comprise different types of Application-Specific Integrated Circuit (ASIC) devices.

19. The management controller of the composable computing system described in claim 17, wherein the first subset of different devices in the composable computing system are accessible when the different devices receive commands/requests from management controller and the management controller adds operations to a queue at the different devices, either directly at the device or through a dispatcher/scheduler component of the composable computing system.

20. The management controller of the composable computing system described in claim 17, wherein the single abstracted device communicates with the second subset of the first subset of different devices via the pre-existing connections without manual intervention.
